(19) United States
(12) Patent Application Publication
(10) Pub. No.: US 2003/0055919 A1
(43) Pub. Date: Mar. 20, 2003

(54) One-click deployment of data processing systems

(76) Inventors: Ryan Patrick Fong, Castro Valley, CA (US); David J. Hu, Union City, CA (US)

Correspondence Address: HEWLETT-PACKARD COMPANY, Intellectual Property Administration, P.O. Box 272400, Fort Collins, CO, 80527-2400, US

(21) Appl. No.: 09/944,313

(22) Filed: Aug. 30, 2001

(51) Int. Cl. G06F 15/177; G06F 15/16

(52) U.S. Cl. 709/220; 709/221; 709/203

(57) ABSTRACT

A method and computer network to deploy a group of data processing systems. One embodiment of the invention involves a method to deploy one or more data processing systems. A second embodiment of the invention involves a computer network to facilitate the intelligent deployment of one or more data processing systems. A third embodiment of the invention involves a computer program embodied on electronically-readable media, containing instructions to deploy one or more data processing systems.

### BACKGROUND OF THE INVENTION

1. Field of the Invention

This invention relates generally to providing a method to facilitate the set-up of a group of data processing systems, and more specifically to providing a method to deploy a group of computers with a specific set of software and hardware parameters.

2. Description of the Prior Art

Businesses have developed several in-house programs and procedures for deploying data processing systems (e.g., computer servers). These in-house programs and procedures have been less than comprehensive, and also lacking in regards to providing easy-to-use interfaces. The complexity of deploying data processing systems has also been approximately proportional to the number of data processing systems involved.

Deployment of data processing systems includes selecting several software and hardware parameters. These parameters are listed in detail below, but include personalization information and options information, as well as other types of parameters (e.g., configuration parameters).

For example, one prior art deployment software product is the PowerQuest DeployCenter (available from PowerQuest, with corporate headquarters in Orem, Utah), which automates the capture and restoration of data (e.g., personal information) on end-user's systems, including network and operating system settings (e.g., this allows the user to elect the operating system settings to be transferred to other computers and affects the way that the operating system functions). The objects transferable during deployment include (but are not limited to): Desktop settings (e.g., for the Windows operating system this could include Active Desktop, Colors, Desktop Icons, Display, Icon Font, Pattern, Screen Saver, Wallpaper, Window Metrics and Start Menu); Personality settings (e.g., for the Windows operating system this could include Accessibility, Internet Browser Settings, Keyboard, Mouse, Printers, Send To Menu, Shell, Sound, Taskbar and User Profiles); Connectivity Settings (e.g., for the Windows operating system this could include Computer Description, Computer Name, DNS configuration, mapped drives, RAS networking connections, shared folders & drives, TCP/IP configuration, WINS configuration, Workgroup and Domain); Files (e.g., files that can be transferred at the same time as the settings).

However, the PowerQuest DeployCenter does not capture (i.e., take a snapshot of the hardware configuration of a reference server, such as the hardware inventory, firmware settings, CMOS settings, boot order (e.g., booting from CD, disk drive, floppy diskette, or network), and the enablement/disablement of embedded hardware. The DeployCenter can only save information that is related to, or on, the actual disk drive being captured. Thus, it does not capture information about the hardware, the firmware settings, CMOS, boot order, or the enablement/disablement of any embedded hardware. It can manipulate the file system format, disk drive partitions, free space, and files.

Another prior art deployment software package is the Rembo Auto Deploy (RAD) package (available from Rembo Technology Sarl, with corporate headquarters in Carouge, Switzerland). This is a system image creation, management, and deployment tool intended to allow an administrator to take a snapshot of an operating system configuration for a computer, including: base disk image, application packages, configuration settings, and specific hardware configurations (such as firmware upgrades). RAD is driven from a central database containing unique parameters for each computer (including the rules that decide which images and software are applied to each computer). Parameters are set prior to deployment.

RAD assembles the target computer's operating system from various building blocks. The first is the base disk image. A base disk image is a copy of the hard disk contents (including the operating system) from a reference computer {e.g., in a Windows operating system this is prepared with the Microsoft System Preparation tool (SysPrep), available from Microsoft Corporation, with corporate headquarters in Redmond, Washington}. On top of the base disk image, an administrator can apply software images. Software images are similar to base disk images, but are related to a specific piece of software. Multiple software images can be merged with the base disk image, and the combined base disk image and software images are written to a hard disk. At the end of the deployment, a SysPrep answer file (or a Linux equivalent file) is created and copied to the hard disk to customize the operating system.

However, the deployment process needs a specialized deployment center and may require manual intervention. In manual mode, RAD requires a user to enter specific computer configuration parameters and choose which software package to install. RAD uses a reference server to take a snapshot of some of the hardware inventory {including PCI devices, and desktop management interface (DMI) information}, disk drive settings, and CMOS settings.

However, RAD does not have features to control embedded hardware settings. RAD only images the first system disk drive or RAID volume as reported by the BIOS; alternate disk drives must be installed using operating system-based tools, or by using command lines. RAD only supports incremental images on the primary OS partition; the operator must use software updates packages with an unattended setup command line to install software on a secondary partition.

A major problem inhibiting deployment of a group of data processing systems is the complexity of setting up the software and parameters of a larger group of data processing systems. It would be desirable to provide a comprehensive method and system to intelligently deploy a group of data processing systems with a specific set of software, hardware firmware versions, and parameters under the centralized control of a graphical user interface (GUI).

### SUMMARY OF THE INVENTION

The present invention provides a comprehensive method and system to facilitate the intelligent deployment of a group of data processing systems with a specific set of software, hardware firmware versions, and parameters under the centralized control of a graphical user interface (GUI). The invention can be implemented in numerous ways, such as by a method, a computer network, or a computer program on electronically-readable media. Three aspects of the invention are described below.

A first aspect of the invention is directed to a method to deploy one or more data processing systems. The method includes capturing deployment information from a reference data processing system to deploy on the one or more data processing systems, wherein the deployment information is stored in a memory; selecting the one or more data processing systems; selecting a package of the deployment information to be deployed on the one or more data processing systems; and intelligently deploying the one or more data processing systems upon receiving a command from a user, wherein intelligently deploying includes referencing the package of deployment information that is stored in the memory.

A second aspect of the invention is directed to a computer network to facilitate the intelligent deployment of one or more data processing systems. The computer network includes one or more data processing systems to be intelligently deployed; one or more reference data processing systems containing deployment information; a means for transmission capable of conveying the deployment information to the one or more data processing systems; and a dedicated data processing system containing deployment information copied from the one or more reference data processing systems, wherein the dedicated data processing system conveys to the one or more data processing systems over the means for transmission a package of deployment information selected from the deployment information, upon receiving a command from a user.

A third aspect of the invention is directed to a computer program embodied on electronically-readable media, containing instructions to facilitate the deployment of one or more data processing systems. The computer program includes a program code segment to capture deployment information from a reference data processing system to deploy on the one or more data processing systems, wherein the deployment information is stored in a memory; a program code segment to select one or more data processing systems to be included in the one or more data processing systems; a program code segment to select a package of the deployment information to be deployed on the one or more data processing systems; and a program code segment to intelligently deploy the one or more data processing systems upon receiving a command from a user, including program code to reference the package of deployment information that is stored in the memory.

These and other objects and advantages of the invention will become apparent to those skilled in the art from the following detailed description of the invention and the accompanying drawings.

### BRIEF DESCRIPTION OF THE DRAWINGS

FIG. 1 illustrates a typical configuration of one or more data processing systems, in accordance with one application of a preferred embodiment of the present invention.

FIG. 2A illustrates partitions on a disk drive X with partitions A, B, and C.

FIG. 2B illustrates two disk drives X and Y with partitions A and B on drive X, and partitions C and D on drive Y, respectively.

FIG. 2C illustrates a partition A shared across multiple disk drives X and Y.

FIG. 3 illustrates some deployment options, according to a preferred embodiment of the present invention.

FIG. 4 illustrates a flowchart representing a typical sequence for booting a system to the PXE device by using WOL, assuming that the system's MAC address is already known to the PXE Server.

FIG. 5 illustrates a flow chart of a method for deploying data processing system(s) in accordance with one embodiment of the invention.

FIG. 6 illustrates a more detailed flow chart of a method for deploying data processing system(s) in accordance with one embodiment of the invention.

FIG. 7 illustrates a flow chart of image capture, in accordance with one preferred embodiment of the invention.

FIG. 8 illustrates a flow chart of deployment selection, in accordance with one preferred embodiment of the invention.

FIG. 9 illustrates a flow chart of the scheduler, in accordance with one preferred embodiment of the invention.

FIG. 10 illustrates a flow chart involving asset management of one or more data processing systems, in accordance with one preferred embodiment of the invention.

FIG. 11 illustrates the relationship between attribute match criteria and various types of deployment, in accordance with various embodiments of the invention.

### DETAILED DESCRIPTION OF THE PREFERRED EMBODIMENTS

The invention provides a method and a system to facilitate the deployment of a group of data processing systems. One more preferred embodiment of the invention is implemented on a computer network that is connected or coupled to what is commonly referred to as the Internet or the World Wide Web.

### Intelligent Deployment

Any type of data processing system deployment, such as one-click deployment, most preferably uses intelligent deployment. Intelligent one-click deployment includes deployment initiation, where the one-click deployment software compares the user-selected hardware and/or software attributes to the target systems. Intelligent deployment also includes testing for a successful match of the target system attributes against the match criteria attributes, where a match indicates a successful deployment candidate (in this case deployment is allowed to continue). However, if the match of attributes is unsuccessful, the one-click deployment software can generate an error/warning to the user before deployment proceeds. Intelligent one-click deployment can also stop deployment when a mismatch of attributes occurs due to target system incompatibility, or suspend the deployment and wait for a user command to ignore the mismatch of attributes and continue the deployment. The attributes originate from a pre-defined list, which the user can include or exclude from the attribute comparison prior to deployment initiation.

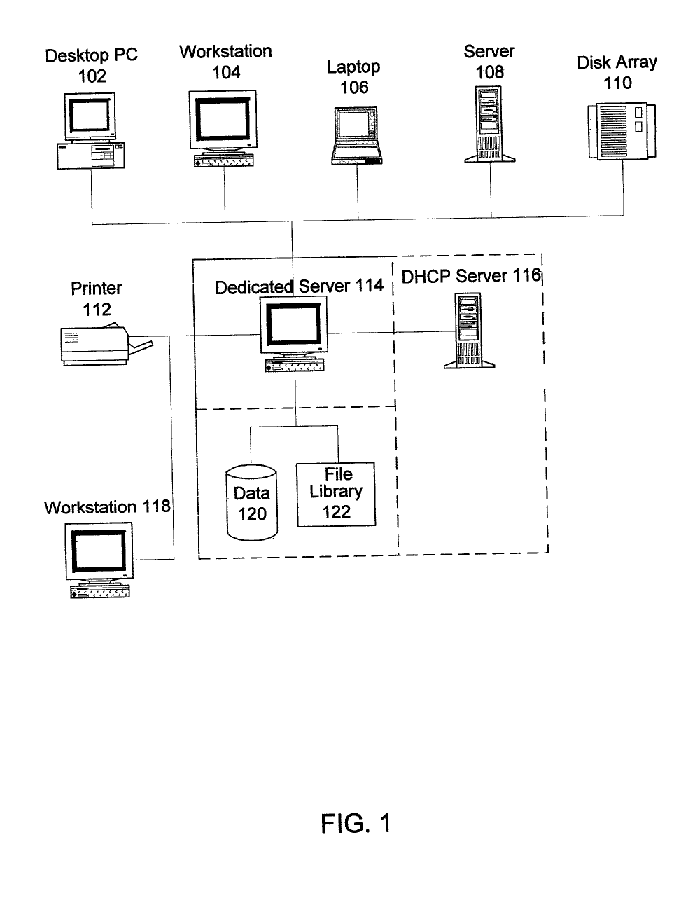

FIG. 1 illustrates a typical configuration of one or more data processing systems, in accordance with one application of a preferred embodiment of the present invention. The desktop personal computer 102, workstation 104, laptop computer 106 server 108, disk array 110, and a printer 112 are connected through a network (e.g., a data processing network) to a dedicated server 114. The dedicated server 114 would typically be running one of the more recent versions of Windows or Linux (e.g., RedHat Linux) on a Netserver/HP Unix server system (or this could be any system capable of running the deployment software of the present invention and the deployment software plug-in components of a vendor), and be connected to a network. Preferably, a Web browser on a workstation 118 can be used to remotely access the dedicated server 114. The dedicated server 114 would typically include a PXE server, a database 120, and a file library 122. The file library 122 contains image and utility libraries normally installed as part of the software of the dedicated server 114. The database 120 and file library 122 may or may not be located on the same data processing system as the dedicated server 114. In one embodiment, the dynamic host configuration protocol (DHCP) server 116 is on the same data processing system as the dedicated server 114, but in another embodiment the DHCP server 116 is on a different data processing system. When a server provides this data processing system network service on the network, it will dynamically configure a data processing system's network settings, including the IP address, subnet, DNS server, lease expiration date, and other settings. In preferred embodiments, a PXE Server is implemented as part of the dedicated server 114. If there is a router between the PXE Server and a Target system, the router must be setup to route the appropriate network packets. A BOOTP packet is a specific type of packet that the router may or may not route depending on its configuration. The router preferably supports all packets that are needed for transmission over the network to target systems.

The reference data processing system and target data processing systems preferably include PXE supporting network cards. Usually the network interface cards (NICs) have PXE boot devices that are always available, but the default boot order may be selectively modified to specify the PXE enabled NIC at the top of the boot order. Preferably, the data processing systems are connected to the same network as the dedicated server. Preferably, the data processing systems support Wake on LAN (WOL), or another wake-up mechanism (listed in Table 3 below), and include network cards with WOL enabled. The dedicated server 114 preferably has a management console running on a workstation in a supported Web browser. The printer 112 is connected to the dedicated server or network for printing asset management reports. Components that may be required in addition to the dedicated server software include: SysPrep from Microsoft and/or an equivalent Linux utility, BIOS and firmware version readers, update utilities, ROM files, configuration binary/text files, configuration utilities from vendors (e.g., utilities for BIOS, SCSI, and RAID), and a supported database (e.g., an ORACLE database).

Before the PXE-boot process can begin, a data processing system may need to be powered-on or rebooted. A more preferred way to power-on a data processing system is through WOL, when the data processing system has WOL capabilities and WOL is enabled.

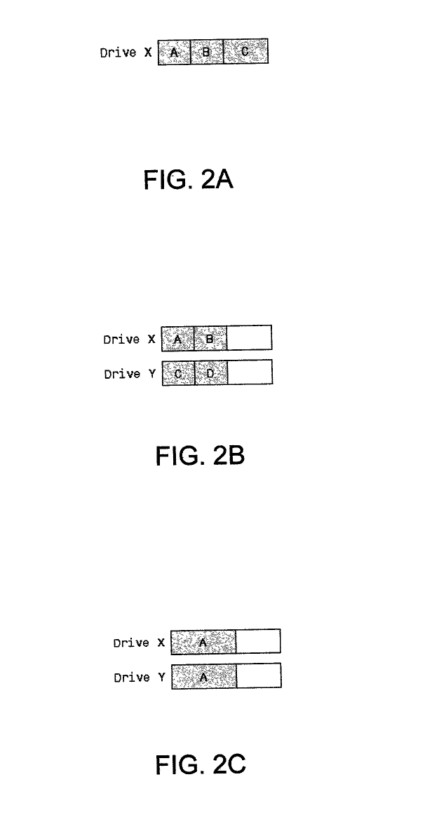

Preferred embodiments of the present invention can deploy multiple partitions and multiple disk drives. The difference between multiple partitions and multiple disk drives is best illustrated by figures. FIG. 2A illustrates partitions on a disk drive X with partitions A, B, and C. FIG. 2B illustrates two disk drives X and Y with partitions A and B on drive X, and partitions C and D on drive Y, respectively. FIG. 2C illustrates a partition A shared across multiple disk drives X and Y.

### Discovery

The discovery program determines the system hardware and firmware configuration information for one or more data processing systems, and saves this information for future reference. This information is preferably saved on a non-volatile memory, such as a magnetic disk drive, a magneto-optic disk drive, a floppy diskette, a compact disc, or a flash memory. Alternatively, the information can be saved on a volatile memory, such as a random access memory (RAM). Table 1 lists some discovery features.

TABLE 1
Discovery Features

| Feature | Description |
|---|---|
| Independent | In preferred embodiments, the discovery program is |
| from External | independent from the implementation of other features, |
| Components | such as the image capture and deployment features. |
| DOS Program | Preferred embodiments are implemented as a |
| | DOS program. |
| Run from | Preferred embodiments can run from a bootable DOS |
| DOS or OS | environment, or from a supported network operating |
| | system (NOS). |
| Remote and | Preferred embodiments can be initiated remotely across |
| unattended | a network connection and can operate without any user |
| | intervention. |
| Data Stored | Preferably, discovery data is added to a database stored |
| for Future | locally as a file (e.g., text, or binary) on the system, |
| Reference | or remotely on a dedicated server, depending on the |
| | Discovery program. |
| Validation | Preferred embodiments support validation against an |
| | existing system's hardware/firmware configuration to |
| | determine whether a system's hardware has changed |
| | since the previous discovery process. |
| Local Storage | Preferred embodiments of local storage discovery obtain |
| Information | some or all of the following information: |
| | Number of physical disk drives. |
| | Firmware version of each physical disk. |
| | Capacity of each physical disk drive. |
| | Number of partitions on each physical disk drive. |
| | Capacity of each partition. |
| | Capacity of un-partitioned space on each disk drive. |
| | File system format on each partition (including support |
| | for a utility partition from Hewlett-Packard (HP) and/or |
| | other vendors). |
| | Physical disk and partition number of the active boot |
| | partition (MBR). |
| | Empty/non-empty status of each partition. |
| | Physical disk and partition number of the NOS drive. |
| | Whether a partition is used exclusively for a page or |
| | swap file. |
| RAID Storage | Preferred embodiments of the invention use discovery to |
| Information | obtain some or all of the following information about |
| | RAID storage: |
| | Drive numbers of logical RAID drives. |
| | RAID configuration. |
| | Number of Disk Array Controllers (DAC). |
| | Vendor for each DAC. |
| | Vendor specific model for each DAC. |
| | DAC BIOS and firmware version information. |
| System | In preferred embodiments, some or all of the following |
| Hardware | system hardware information is obtained through |
| Information | discovery: |
| | System model identification. |
| | System Basic Input Output Software (BIOS) version. |
| | System F2 setup configuration (CMOS & related chips, |
| | random access memory (RAM) information (e.g., |
| | capacity, type, speed, number of chips, and error |
| | correcting capability (ECC)), central processing unit |
| | (CPU) information, (e.g., vendor, model, & speed)). |
| | Video card information (e.g., vendor and BIOS/firmware |
| | version). |
| | Maximum vertical refresh rate of an attached monitor. |
| | Network Interface Card (NIC) detection. |
| | Small Computer Serial Interface (SCSI) controller |
| | information, such as vendor, model and firmware |
| | versions. |
| | Enhanced Integrated Drive Electronics (EIDE/IDE) |
| | controller information (e.g., current configuration). |
| | Peripheral Computer Interface (PCI) slot information, |
| | including the number of PCI slots and the types of |
| | devices in the slots. Intel Standard Architecture (ISA) |
| | slot information, including the number of ISA slots and |
| | the types of devices in the slots. |
| | Advanced Graphics Port (AGP) slot information, includ- |
| | ing the vendor, model, and firmware version of the |
| | card in the slot. |

### Image Capture

Preferred embodiments of image capture can be used to capture a system's hardware configuration, base software image, and/or incremental software images. Table 2 lists some differences between discovery and image capturing. Table 3 follows Table 2 and lists some preferred image capturing features.

TABLE 2
Discovery and Image Capturing

| Feature | Description |
|---|---|
| Discovery | Discovery preferably automatically runs the |
| | discovery action to obtain a system's hardware |
| | and software information. |
| Image Capturing | Image capture preferably captures the hardware |
| Captures Reference | configuration, base software image, and/or |
| System Configuration | incremental software images from a reference |
| and Images | system. The capturing process is non- |
| | destructive to the reference system's existing |
| | configuration. |

A more preferred embodiment of the invention provides a programming code segment to capture hardware information (e.g., both text data and/or binary data), and to transmit the hardware information (e.g., CPU information, PCI information, BIOS information, and so forth) back to a dedicated server. Third-party utilities (e.g., deployment utility software from vendors like Rembo or PowerQuest) can be used, if necessary, to capture or deploy the data (e.g., software image(s) on the hard drive(s) of reference systems) for Intel-based systems, and can be used to deliver the hardware info capture and configuration program code segments to the data processing systems. Additionally, third-party utilities may be used to capture and deploy software image(s) on non-Intel-based data processing systems. A preferred embodiment provides a database for storing references to software image store(s) after software image(s) are put on the dedicated server. In addition to storing references to software image(s), other value-added information (e.g., hardware info) is stored in the database of the dedicated server that stores the software image(s).

TABLE 3
Some Preferred Image Capture Features

| Feature | Description |
|---|---|
| Hardware | Captures a reference system's profile. To create a hard- |
| Configuration | ware configuration for a system, image capture can |
| | obtain some of following information: |
| | System BIOS Vendor, Version, Release Date, and/or |
| | ROM Size. |
| | System BIOS configuration (captured as a text or binary |
| | file). |
| | All PCI (and non-PCI) device BIOS and firmware |
| | versions and configurations, including Redundant Arrays |
| | of Inexpensive Disks (RAID), SCSI controllers, and |
| | other types of disk controllers. |
| | Advanced Graphics Port (AGP) video BIOS & firmware |
| | versions. |
| | Motherboard-embedded device information, BIOS & |
| | firmware versions. |
| | System information {e.g., manufacturer, product name, |
| | version, serial number, universal unique identification |
| | (UUID), and wake-up mechanism (e.g. LAN Remote, |
| | Power Switch, PCI, Modem Ring, APM Timer, and |
| | equivalents)}. |
| | Processor information (e.g., socket designation, type, |
| | family, manufacturer, ID, version, voltage, various clock |
| | frequencies). |
| | Cache information (e.g., cache configuration (internal/ |
| | external), maximum cache size, installed cache size, and |
| | system cache type). |
| | Memory Devices (e.g., location, use, memory error cor- |
| | rection, maximum capacity, and number of memory |
| | devices, memory array handle, total width in bits, data |
| | width in bits, size, form factor (i.e., type of RAM; |
| | e.g., SDRAM, DIMM, SIMM DDR, and so forth), |
| | device set, device locator (i.e., to identify the physical |
| | socket or board position), back locator (i.e., to identify |
| | the physical bank of the device)}. |
| | Networks (e.g., LAN, WAN, Internet, wireless networks, |
| | and direct connection). |
| | Preferred embodiments dynamically create a DOS boot- |
| | able image containing the system profile files and |
| | utilities. Preferably, the hardware configuration supports |
| | a unique identifier and a link to the reference |
| | system's system profile in the database. |
| Base Software | A preferred embodiment captures a base software image, |
| Image | typically including a NOS image, of a reference system. |
| | A base software image is associated with a link to the |
| | reference system's profile in the database. |
| | Preferred embodiments support some or all of the fol- |
| | lowing NOS images: |
| | Windows NT 4.0, Windows 2000 Server, Windows XP |
| | RedHat Linux, SuSe Linux, Debian Linux |
| | HP-UX |
| | and future upgrades and enhancements of the |
| | above NOS. |
| Incremental | A preferred embodiment captures incremental software |
| Software | images by differencing the current software configuration |
| Image | with an existing base software image. Preferably, |
| | incremental software images are linked to the |
| | reference system's system profile and to the base soft- |
| | ware image in the database. |
| Multiple | Preferably, the image capture process supports imaging |
| Drives and | multiple partitions on a drive, multiple drives and |
| Partitions | partitions across one or more physical drives. Preferably, |
| | the image capture process automatically captures all |
| | partitions on all drives, and links the images together as a |
| | base or incremental software image. |
| Complete | Allows the user to create a hardware configuration and |
| (“One-Click”) | base software image in a single action. |
| System | |
| Capture | |

### Deployment

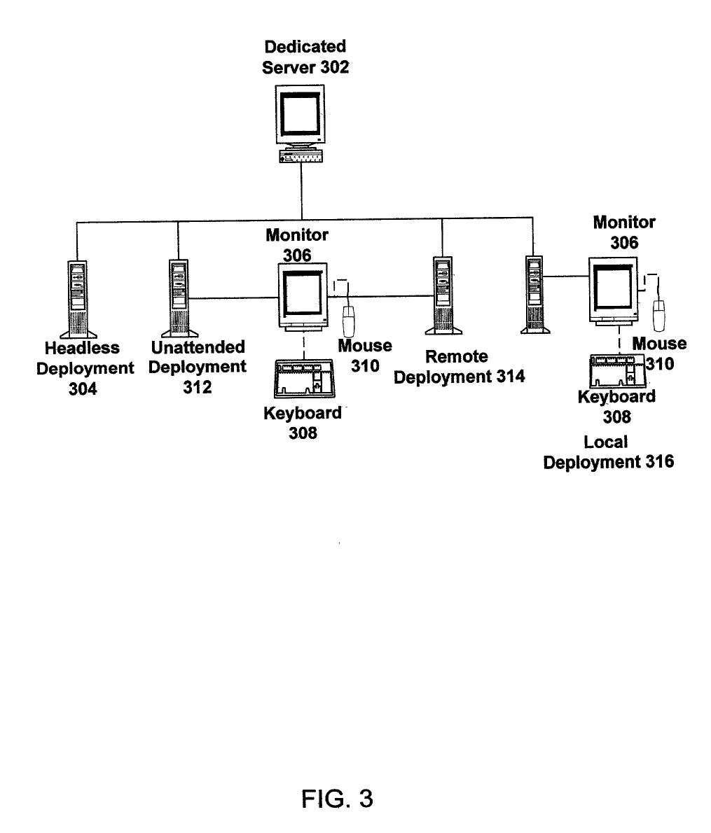

Deployment in preferred embodiments of the invention are done remotely without any interaction from the user and can be done in headless systems. FIG. 3 illustrates some deployment options, according to a preferred embodiment of the present invention. The dedicated server 302 is connected to various data processing systems. Headless Deployment 304 involves a data processing system that is not connected to a monitor 306, keyboard 308, or mouse 310. The data processing system has headless BIOS support and deployment typically is both unattended and remote in this deployment option. Unattended Deployment 312 does not require human interaction. The data processing system may or may not be headless. Remote Deployment 314 involves a user that has access to the target data processing system's console through console re-direction. The user does not have to be physically located at the target system, but the user is able to respond to prompts for user input on the target console. Both Unattended Deployment 312 and Remote Deployment 314 may involve an optional keyboard 308, an optional mouse 310, and an optional monitor 306. Local Deployment 316 involves a data processing system connected directly to a monitor 306, an optional keyboard 308, and an optional mouse 310. Deployment is controlled from the target data processing system's console. This typically involves a deployment graphical user interface (GUI) that can be accessed from the target's console. An alternative embodiment can include a centralized deployment server that is able to control deployment on this system without the need for a GUI on the target system.

A more preferred option for data processing system deployment is Headless Deployment 304, which assumes that the deployment is remote and unattended. Another preferred option is remote-unattended deployment, which appears to the user as a Headless Deployment 304, although the data processing system is physically connected to a console. The Local Deployment 316 option supports PCs and laptop computers.

Preferred embodiments of the present invention can deploy multiple data processing systems, and deploy hardware configurations and software images as specified by the Image Capture process. Table 4 lists a summary of preferred deployment features that can be supported as necessary in various embodiments of the invention.

TABLE 4
Preferred Deployment Options

| Feature | Description |
|---|---|
| Headless | Preferably, the system supports headless operation. Even |
| Deployment | if the system does not support true headless deployment, |
| | preferably deployment can done remotely and |
| | unattended. |
| Remote | A preferred embodiment supports remote deployment |
| Deployment | from a centralized user interface. More specifically, the |
| | user will not need to be physically located at the target |
| | system. In this case, deployment may or may not require |
| | user interaction with the target's console. |
| Local | Local Deployment involves a data processing system |
| Deployment | connected directly to a monitor, an optional keyboard, |
| | and an optional mouse. Deployment may be controlled |
| | from the target data processing system's console, |
| | controlled from a dedicated server, or from a |
| | centralized user interface. |
| Unattended | Preferably, deployment does not need user interaction. |
| Deployment | Unattended deployment may or may not be done |
| | remotely. |
| Group | Deployment preferably supports multicast technologies |
| Deployment | and handles multiple system and images with one |
| | deployment action. |
| Deploy | Preferably, deployment of a hardware |
| Hardware | configuration is done alone, or as part of deploying a |
| Configuration | complete system. If deployed alone, the hardware con- |
| | figuration should not be destructive to the target's |
| | existing software configuration. Preferably, hardware |
| | configuration utilities are deployed with a bootable DOS |
| | image, along with the necessary configuration data files |
| | created during hardware configuration image capture. |
| | Preferably, the DOS image is used to run the hardware |
| | and firmware utilities, and it is removed from the target |
| | system when the utilities are finished. Preferably, in |
| | order to deploy the hardware configuration, the system |
| | profile associated with the reference system matches the |
| | target's system profile. |
| Deploy Base | Preferably, software images are deployed as specified |
| Software Image | by the Image Capture process. The target's system |
| | profile preferably matches the reference system's profile. |
| | In addition to matching the target and reference |
| | system profiles, deployment of software or incremental |
| | images uses some or all of the following database |
| | information: |
| | Logical drive of each partition. |
| | Number of partitions on each drive. |
| | Partition size. |
| | Partition file system format (including HP's |
| | utility partition). |
| | Whether it is a swap partition. |
| | Disk and partition number of the active boot partition. |
| | A link to the image associated with each partition. |
| | In preferred embodiments, deployment creates and |
| | formats partitions and deploys images as part of base or |
| | incremental software images. |
| | The reference system's profile preferably determines how |
| | the partitions are created, and the image restored on |
| | each partition. |
| Deploy | Preferably, incremental images can be deployed alone, |
| Incremental | with a hardware configuration, or with a base software |
| Software Image | image. Preferred embodiments ensure that incremental |
| | images are deployed on top of the base software image |
| | from which they were created during Image Capture. |
| Multiple Drives | A preferred embodiment supports deployment to multiple |
| and Partitions | partitions on a single drive, multiple drives, and |
| | partitions across multiple physical drives. |

Preferred embodiments of the invention can update a data processing system's hardware configuration in a non-destructive manner, both before software image deployment, and on a data processing system that has already been configured. In other words, the hardware configuration can be updated at any time without modifying the remaining portion of the configuration of the data processing system.

### Re-Deployment

The most preferred embodiment is able to deploy new or additional hardware configuration and/or software image(s) to a system that has already been deployed. Re- deployment could be used to update a systems hardware configuration, deploy additional software components with incremental images, or completely change the configuration of a system by deploying a different base software image. Re- deployment involves regaining control over a system that is currently running a network operating system (NOS). Table 5 lists selectively included re-deployment features.

TABLE 5
Some Preferred Re-Deployment Features

| Feature | Description |
|---|---|
| Cancel | Preferably, the user may cancel the deployment process |
| Deployment | during any stage. When canceling deployment, the user is |
| | preferably given a choice to either rollback deployment, or |
| | to simply cancel the process. Since certain stages of |
| | deployment are difficult to cancel (e.g., restoring an image), |
| | cancellation preferably takes place at the earliest possible |
| | step of deployment. |
| Restart | Preferably, the deployment process may be restarted after |
| Deployment | cancellation, or once a deployment error has been corrected. |
| | Preferably, the deployment process can resume at the last |
| | uncompleted stage. |
| Rollback | Preferably, deployment can be used to rollback a system |
| Deployment | to a previous State (e.g., after canceling a deployment |
| | process, so that the system can be deployed back to the |
| | previous deployment state). |
| Rules-Based | Preferably, the user is able to define a set of rules for |
| Deployment | automatically deploying configurations and images. |

### Asset Management

In preferred embodiments, asset management includes database operations, user administration, and a scheduling utility. Table 6 lists some preferred asset management features.

TABLE 6
Asset Management Features

| Feature | Description |
|---|---|
| Reports | In preferred embodiments, the user is able to define |
| | reports, which can be printed and/or saved to a file. |
| | Typical reports include: |
| | Systems. |
| | System details (e.g., history, system profile, |
| | action status). |
| | Hardware configuration and software images. |
| | Utility files. |
| | Groups. |
| | Group details, such as action status. |
| User-Defined | Preferably, the user is allowed to create groups of |
| Groups | systems for purposes such as deployment or discovery. |
| Rule-Based | Grouping rules can be maintained in the deployment |
| Grouping | database and used to automatically place a new system |
| | in an existing group. |
| Rule-Based | Deployment rules can be maintained in the database for |
| Deployment | automatic deployment of hardware configurations or |
| | images. |
| Validation | Preferably, asset management supports validation of |
| | systems, groups, hardware configurations, and images by |
| | matching system profiles. System profiles preferably |
| | match some or all of the following: |
| | System model. |
| | Number and size of hard drives. |
| | PCI card data. |
| | Number and size of partitions (unless the system is a new |
| | target). |
| | NOS (unless the system is a new target). |
| | And other attributes mentioned in the discovery section. |
| Utility | Preferred embodiments of the invention allow the user to |
| Library | add, update, or delete files in the utility library (for use |
| | during discovery, image capture, or deployment). |
| Unique | Preferred embodiments of the invention allow the user |
| System | to insert, modify or delete user-defined system |
| Information | information. User-defined system information can |
| | include one or more of the following: |
| | IP address(es) or DHCP. |
| | Network name. |
| | Organization name. |
| | Domain. |
| | User name and password. |
| | Time zone and language. |
| | Regional options. |
| | Network options. |
| Default | Preferably, unique system information is automated by |
| System | allowing the user to enter default information for selected |
| Information | systems. Preferred embodiments use the default |
| | information entered to automatically create unique |
| | information for each of the selected systems. |
| Pre-Populate | One preferred embodiment can pre-populate the database |
| Database with | with system profile information from the user interface or |
| System | from a text file, so that the system information is present |
| Information | and the user can set up groups and add user-defined data |
| | before a system is connected to the network. |

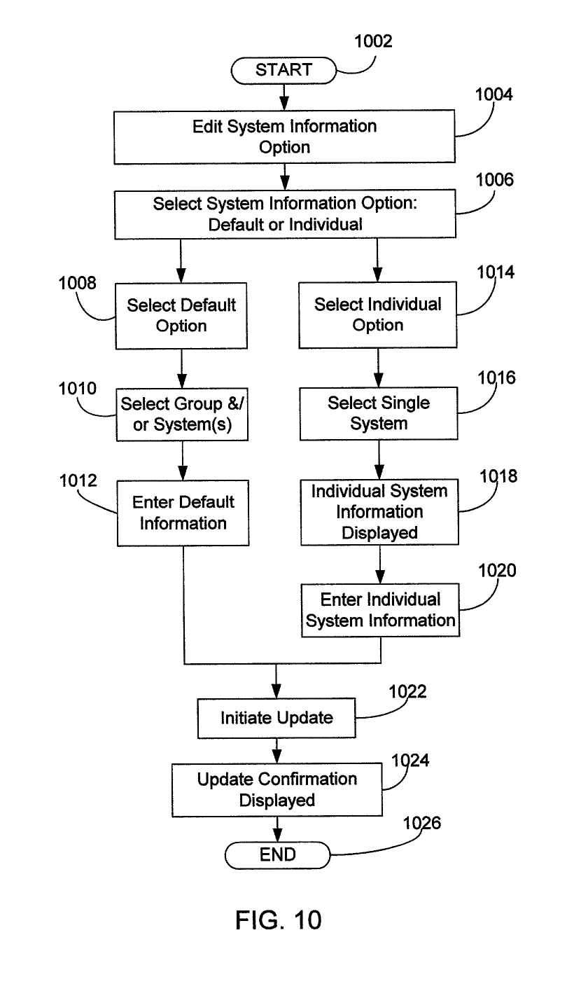

In preferred embodiments of the invention, the user will be able to create rules that will apply to all deployments within a group, or across groups, that will automatically affect what is deployed to a data processing system according to whatever knowledge is already known about a target data processing system. Rules will be explained in more detail in the discussion of FIG. 10 below.

### Graphical User Interface (GUI)

The GUI should be intuitive and easy to learn while providing advanced deployment and asset management features. Table 7 lists some preferred GUI features.

TABLE 7
Preferred Graphical User Interface Features

| Feature | Description |
|---|---|
| Database | Preferably, the database is abstracted from the user. |
| Abstraction | |
| Web | Preferably, the GUI runs on a Web server, which allows |
| Application | the user interface to be accessed remotely, and supports |
| | Web browsers. |
| Localization | Preferably, all text is placed in a centralized set of |
| | files to support localization in several languages. |
| Command | In one preferred embodiment, GUI controls are provided |
| Controls | to initiate actions, get user input, and create a natural |
| | workflow. |
| Display | In one preferred embodiment, the GUI displays action |
| Status | status and shows real-time progress whenever possible. |
| Cancel | Preferably, the user can initiate the cancellation of long |
| Operations | operations from the GUI. |
| Asset | Preferably, the GUI supports asset management grouping |
| Management | and imaging features. Preferably, the details of individual |
| Support | systems and images can be displayed, even when they are |
| | part of a group. |
| Save and Load | Preferably, the GUI saves and loads files and user |
| Files and | preferences. For example, the user can save user-defined |
| Configurations | reports for future use and the user can add new files to |
| | the utility library. Preferably, the saved data may be |
| | on the local system or the dedicated deployment server. |
| Print Reports | Preferably, reports can be printed to hardcopy or to a file. |
| | Possible file formats include CSV, tab-delimited, Excel |
| | Spreadsheet, HTML, and XML. |

### General Features

Various preferred embodiments of the invention can include some or all of the preferred general features listed below in Table 8.

TABLE 8
Preferred General Features

| Feature | Description |
|---|---|
| Platform | In preferred embodiments, the dedicated server runs on |
| Independence | Intel Architecture-based servers running Windows. The |
| | preferred embodiment is a generic solution that runs on |
| | server hardware from various vendors (e.g., Hewlett |
| | Packard, Compaq, Dell, or IBM). |
| Database | In preferred embodiments of the invention, the dedicated |
| Independence | server works with industry standard, JDBC compliant |
| | relational databases (e.g., Oracle, SQL Server, and DB2) |
| | and supports database independence. |
| Action Status | Preferably, all actions, such as discovery and deploy- |
| | ment, report status back to the dedicated server and/or |
| | database, and the user can view the status from the |
| | user interface. |
| Action History | Preferably, the deployment database is updated with the |
| | action history of each system, and the user can check the |
| | previous history of any system from the user interface. |
| Fail-over | Preferred embodiments support the use of multiple |
| and Load | dedicated servers and databases (e.g., for fail-over and |
| Balancing | load balancing purposes). A second dedicated server and/ |
| | or database can serve as a backup, in case the primary |
| | dedicated server or database is unavailable. |
| Non- | Preferably, the system's current hardware and software |
| Destructive | configuration is not destroyed, except when deploying a |
| | base software image. |

Preferably, the present invention will support data processing system deployments in locations where network connectivity is not available by providing bootable CD or diskette sets. These CDs or diskettes can be used for deploying any data processing system, with the option of letting the user enter computer configuration settings or specific software packages. Furthermore, the present invention will preferably separate the base image from the application software package images, so that even if the application software packages are created on a specific platform (the reference computer), they can be deployed to other platforms (other system images) without requiring modifications.

Preferably, the present invention will be capable of deploying different configurations across several data processing systems simultaneously by using a multicast transport protocol. Multicasting makes it possible to optimize network usage, since files that are needed by several data processing systems will only be sent once, instead of being sent to each data processing system individually. Preferably, status reports are sent to a central console to help an administrator control the deployment.

A PXE-boot process is preferred, but not required on data processing systems with an Intel architecture. A PXE-boot process is not necessary for data processing systems with a Hewlett-Packard proprietary architecture (e.g., the Prism architecture). Before the PXE-boot process can begin, a system may need to be either powered on or rebooted. The ideal way to power on a system is through Wake-On-LAN (WOL), which requires the system to have WOL capabilities and for WOL to be enabled.

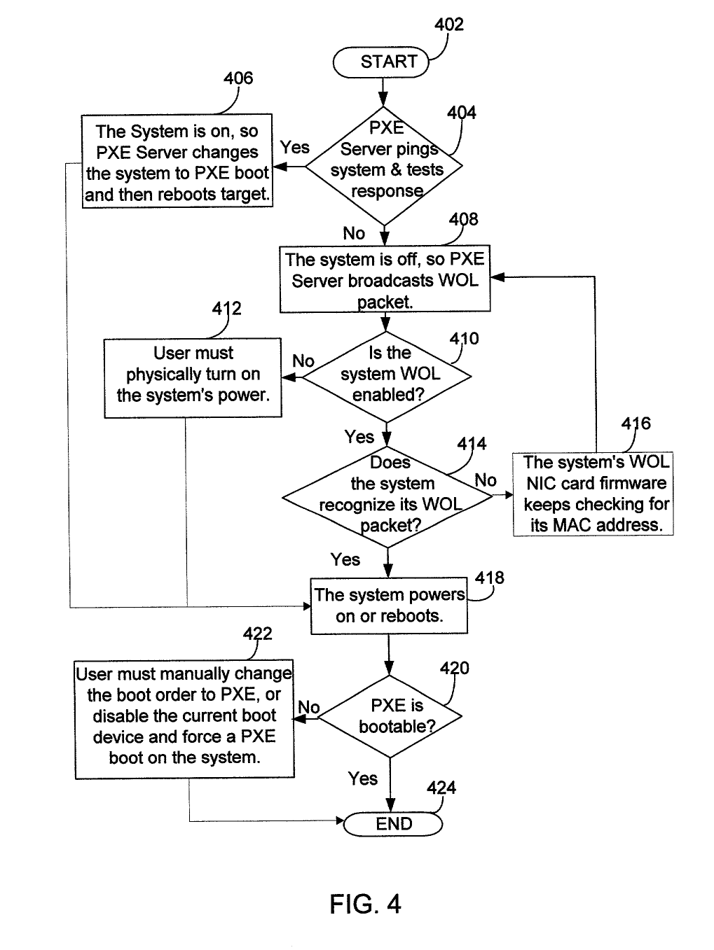

FIG. 4 illustrates a flowchart representing a typical sequence for booting a data processing system to the PXE device by using WOL, assuming that the data processing system's MAC address is already known to the PXE Server. The sequence starts in operation 402. In operation 404, the PXE Server pings the data processing system and tests for a response. The data processing system's MAC address must be pre-entered into the database for this process to be completely unattended. If the test of operation 404 gets a response, then the data processing system is on, so operation 406 is next, where the PXE Server changes the data processing system for a PXE boot and then reboots the target data processing system(s), and operation 418 is next. If the test of operation 404 gets no response, then the data processing system is off, so operation 408 is next, where the PXE Server broadcasts a WOL packet to the data processing system(s). Operation 410 is next, where a test is made to determine if the data processing system is WOL enabled. If the test of operation 410 determines that it is not WOL enabled, then operation 412 is next, where the user physically turns on the data processing system(s) power. If the test of operation 410 determines that the data processing system(s) are WOL enabled, then operation 414 is next, where the data processing system(s) are tested to determine if they recognize a WOL packet. If the test of operation 414 determines that the data processing system(s) do not recognize a WOL packet, then operation 416 is next, where the data processing system(s) WOL NIC card firmware keeps checking for its MAC address and returns to operation 408. If the test of operation 414 determines that the data processing system recognizes its WOL packet, then operation 418 is next, where the data processing system powers-on or reboots. Operation 420 is next, where a test is made to determine if the PXE is bootable. If the PXE is bootable, then operation 424 is next, and the PXE boot process can begin. If the PXE is not bootable, then operation 422 is next, where the user manually changes the boot order to PXE, or disables the current boot device and forces a PXE boot on the data processing system(s). Then operation 424 is next, which where the PXE boot process begins.

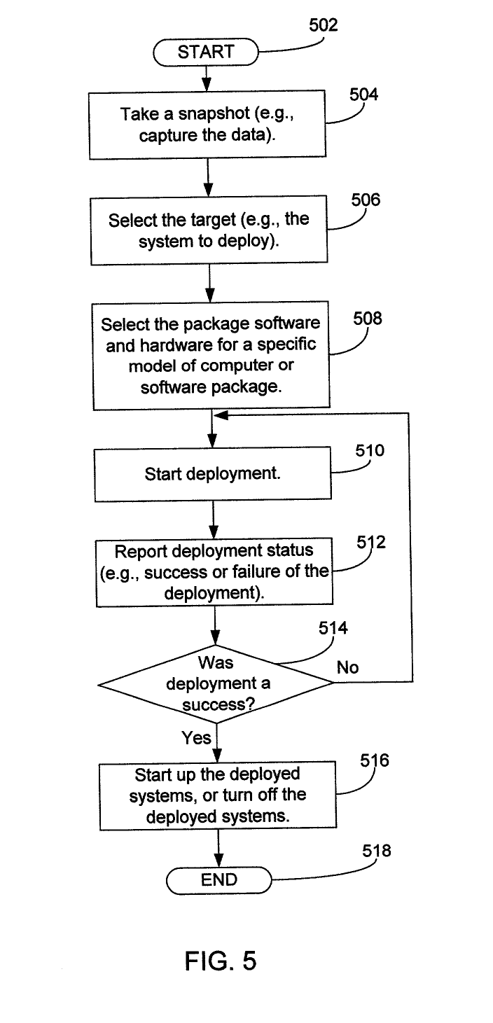

FIG. 5 illustrates a flow chart of a method for deploying data processing system(s) in accordance with one embodiment of the invention. The method starts in operation 502. In operation 504, a snapshot is taken to capture the data needed for deployment. In operation 506, the target data processing system(s) are chosen for deployment. In operation 508, the package software and hardware for a specific model of data processing system (e.g., a computer) or software package are chosen. In operation 510, the deployment is started. Operation 512 is next, where the deployment status for the success or failure of deployment of the data processing system(s) is reported. Operation 514 is next, where a test is made to determine if the deployment was successful. If the deployment was successful, then operation 516 is next, where the deployed data processing system(s) are started up, or turned off. If the deployment was not successful, then operations 510, 512, and 514 may be repeated. In an alternative embodiment, the flow would be directly from operation 514 to operation 518, ending the unsuccessful deployment operation without any further attempts. In operation 518, the method ends.

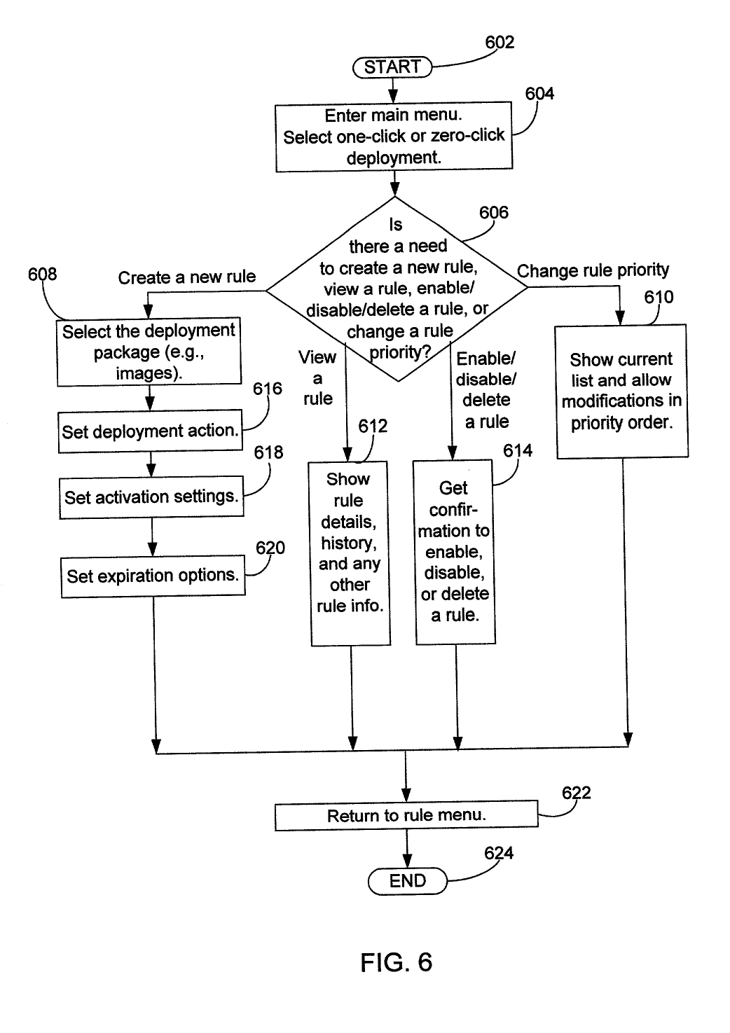

FIG. 6 illustrates a more detailed flow chart of a method for deploying data processing system(s) in accordance with one embodiment of the invention. The method starts in operation 602. In operation 604, the deployment process begins by the selection of the type of action needed. In operation 606, a test is made to determine if there is a need for a new rule, to view a rule, enable/disable/delete a rule, or change a rule priority. If a new rule is needed, then operation 608 is next, where the deployment package is selected (e.g., the images of the data processing system). Then operation 616 is next, where the deployment action is set. Operation 618 is next, where the activation settings are set. Operation 620 is next, where the expiration options are set. Then operation 622 is next with a return to the rule menu. If the test of operation 606 determines there is a need to view a rule, then operation 612 is next, where the rule details, rule history, and associated rule information is shown. Then operation 622 is next with a return to the rule menu. If the test of operation 606 determines there is a need to enable a rule, disable a rule, or delete a rule, then operation 614 is next, where a request for confirmation is made to enable the rule, disable the rule, or delete the rule. Then operation 622 is next with a return to the rule menu. If the test of operation 606 determines there is a need to change a rule priority, then operation 610 is next, where a the current list of rule priorities is shown and modifications are allowed. Then operation 622 is next with a return to the rule menu. The method ends in operation 624. Preferably, the rules are active in the background of the deployment center, and the test includes asking the user for input from the GUI.

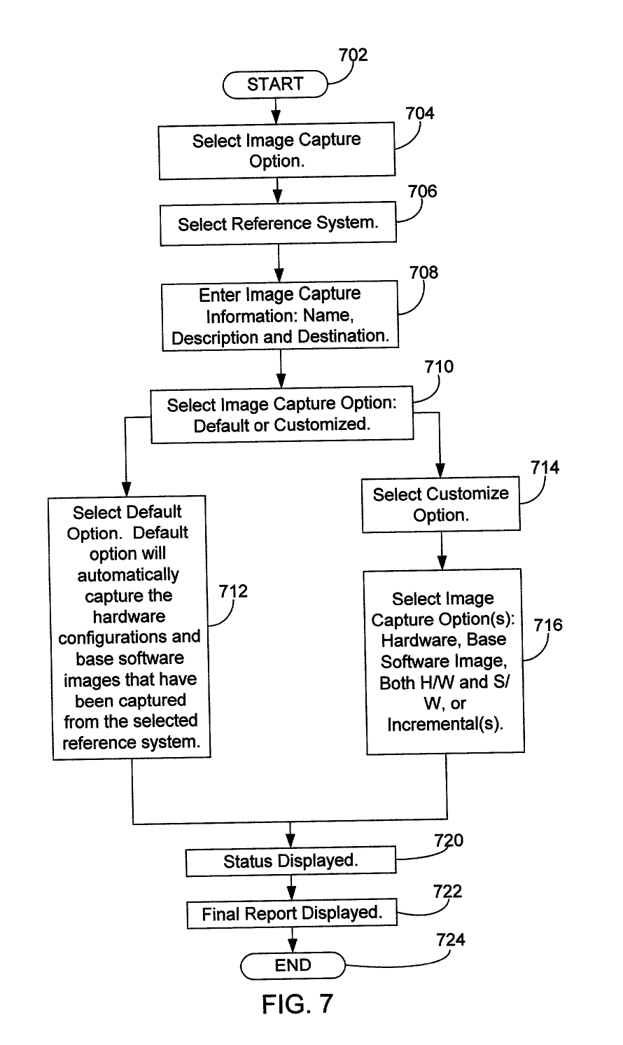

FIG. 7 illustrates a flow chart of image capture, in accordance with one preferred embodiment of the invention. The method starts in operation 702. In operation 704, the user selects image capture (e.g., from a GUI or menu). Operation 706 is next, where the user selects the reference data processing system. Operation 708 is next, where the user enters image capture information (e.g., name, description, and destination for the image) about data processing system(s). Operation 710 is next, where a test determines if a default image capture, or a customized image capture, is to be made. If the test of operation 710 determines it is a default image capture (i.e., if the user selected the default image capture option), then operation 712 is next, where there is an automatic image capture of all hardware configurations and images from the selected reference data processing system. If the test of operation 710 determines it is a customized image capture, then operation 714 is next, where the user selects the customize option. Operation 716 is next, where hardware, base software image, or incremental image capture options are selected. Operation 720 is next, where the image capture status is displayed. Operation 722 is next, where the final report on the image capture is displayed. Operation 724 is next, where the method ends.

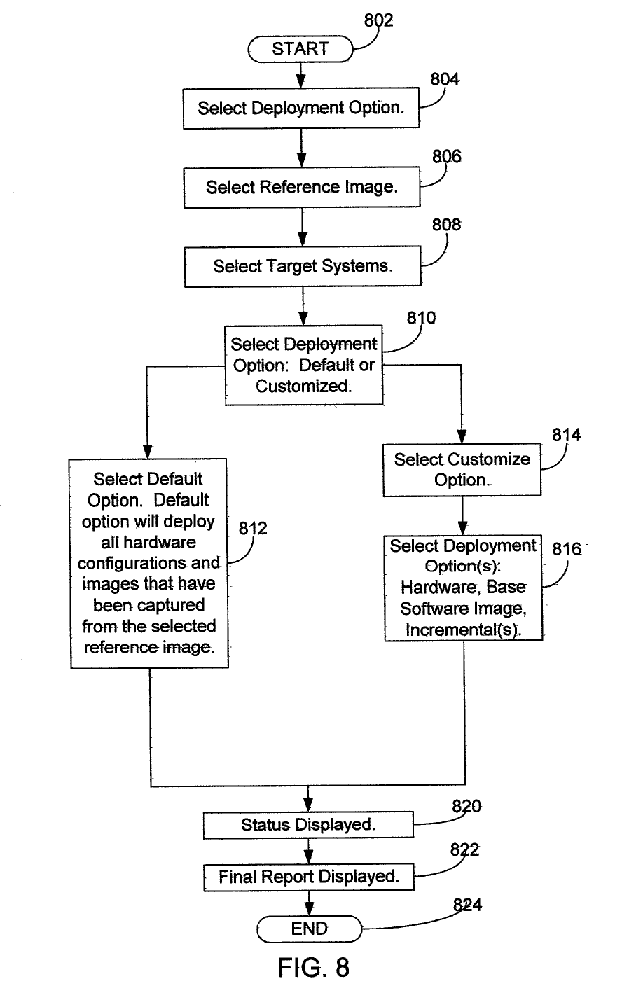

FIG. 8 illustrates a flow chart of deployment selection, in accordance with one preferred embodiment of the invention. The method starts in operation 802. In operation 804, the user selects deployment (e.g., from a GUI or menu). Re-deployment is preferably done automatically as part of deployment. The user should not have to select a separate re-deployment option. Operation 806 is next, where the user selects the reference image. Operation 808 is next, where the user selects the target data processing system(s) (e.g., by hostname, IP address, MAC address, location, model, hardware accessories, and so forth). Operation 810 is next, where a test determines if a default deployment or customized deployment is to be made. If the test of operation 810 determines it is a default deployment (a user selection), then operation 812 is next, where all hardware configurations and images that been captured from the selected reference image will be deployed. If the test of operation 810 determines it is a customized deployment, then operation 814 is next, where the user selected the customize option. Operation 816 is next, where hardware, base software image, or incremental deployments are selected. Operation 820 is next, where the deployment status is displayed. Operation 822 is next, where the final report on the deployment is displayed. Operation 824 is next, where the method ends.

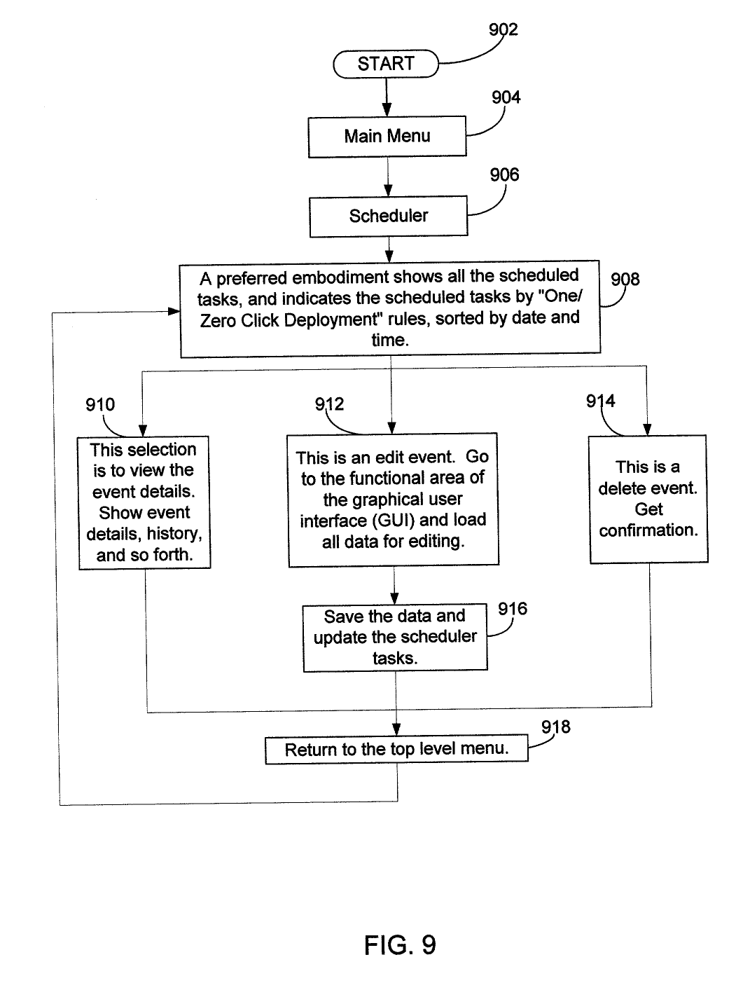

In a more preferred embodiment, events are added and may be scheduled using the functional area menu item. Then scheduled events may be manipulated using the scheduler options shown in FIG. 9, where the rules listed in FIG. 6 are also seen.

FIG. 9 illustrates a flow chart of the scheduler, in accordance with one preferred embodiment of the invention. The method starts in operation 902. In operation 904, the user begins by entering a GUI main menu. Operation 906 is next, where the scheduler menu is entered. Operation 908 is next, where all the scheduled tasks are shown (including the one-click or zero-click deployment rules), and indicated by one-click or zero-click deployment rules, sorted by date and time (or by some other convenient characteristic). A test is made to determine if the selection is to view the event details, edit an event, or delete an event. If the test of operation 908 determines the event details are to be viewed, then operation 910 is next, where the event details, event history, and other information are shown. Then operation 918 is next, where there is a return to the top-level menu. If the test of operation 908 determines an event is to be edited, then operation 912 is next, where the event editing functional area of the GUI is entered and all the data for event editing is loaded. Then operation 916 is next, where the data is saved and the scheduler tasks are updated. Then operation 918 is next, where there is a return to the top-level menu. If the test of operation 908 determines that an event is to be deleted, then operation 914 is next, where a confirmation is requested before the event deletion proceeds. Then operation 918 is next, where there is a return to the top-level menu.

FIG. 10 illustrates a flow chart involving asset management of one or more data processing systems, in accordance with one preferred embodiment of the invention. The method starts in operation 1002. Operation 1004 is next, where edit system information option is selected. Operation 1006 is next, where the system information option is selected: default information or individual information. If the test of operation 1006 determines a default information option is selected, then operation 1008 is next. Then operation 1010 is next, where the group and/or system(s) are selected. Then operation 1012 is next, where the default information is entered. Then operation 1022 is next, where the update is initiated. If the test of operation 1006 determines an individual information option is selected, then operation 1014 is next. Then operation 1016 is next, where the single system is selected. Then operation 1018 is next, where the individual system information is displayed. Then operation 1020 is next, where the individual system information is entered. Then operation 1022 is next, where the update is initiated. Operation 1024 is next, where an update confirmation is displayed. The method ends in operation 1026.

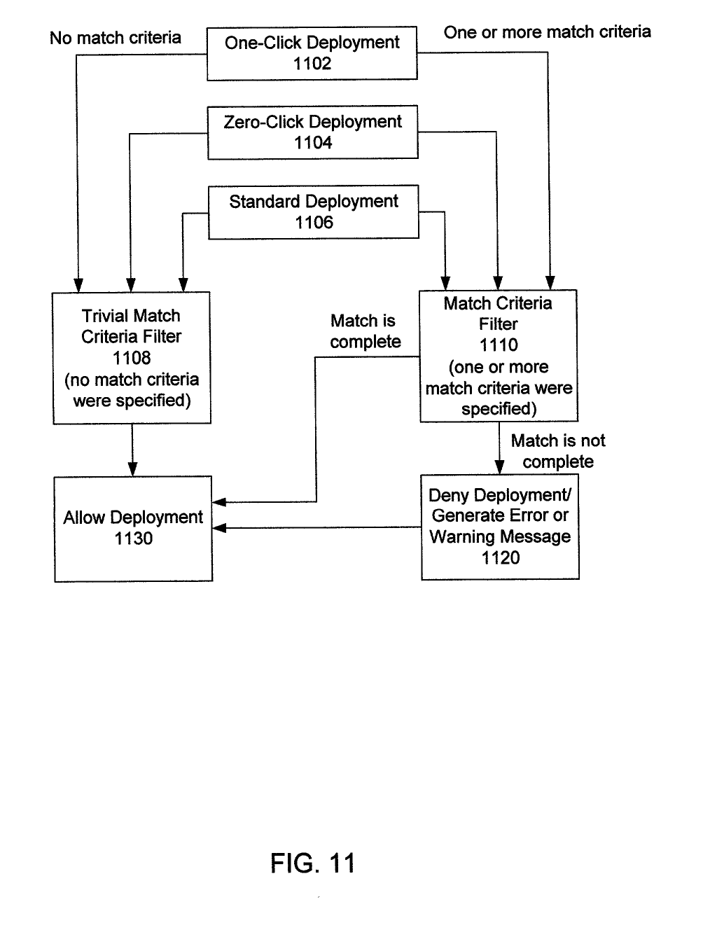

FIG. 11 illustrates the relationship between attribute match criteria and various types of deployment, in accordance with various embodiments of the invention. Three different types of deployment embodiments are shown: one-click deployment 1102, zero-click deployment 1104, and standard (i.e., multi-click) deployment 1106. In cases where there is no attribute match criteria specified, deployment involves a “trivial filter” 1108. In cases where there is one or more attribute match criteria specified, deployment involves a “match criteria/filter” 1110. In the case where the deployment is done through the “trivial filter” 1108, the next step is to “allow deployment” 1130. In the case where there is a mismatch in attribute matching in the “match criteria/filter” 1110, the next step is to “generate error/warning” 1120, which is then followed by the step “allow deployment” 1130. Preferred embodiments handle an attribute match failure by generating an error or warning before automatically continuing with deployment (e.g., when there is a “minor” mismatch/error in attributes), by generating an error or warning and stopping deployment (e.g., when there is a “major” mismatch/error in attributes), or by generating an error or warning, and suspending deployment until a user overrides the condition and instructs the deployment software to continue with deployment (e.g., when there is a mismatch/error in attributes).

The exemplary embodiments described herein are for purposes of illustration and are not intended to be limiting. Therefore, those skilled in the art will recognize that other embodiments could be practiced without departing from the scope and spirit of the claims set forth below.

What is claimed is:

1. A method to deploy one or more data processing systems, comprising:
capturing deployment information from a reference data processing system to deploy on said one or more data processing systems, wherein said deployment information is stored in a memory;
selecting said one or more data processing systems;
selecting a package of said deployment information to be deployed on said one or more data processing systems; and
intelligently deploying said one or more data processing systems upon receiving a command from a user, wherein said intelligently deploying is based on said deployment information that was captured, and includes referencing said package of said deployment information that is stored in said memory.

2. The method of claim 1, wherein said deployment information in said memory is stored on a dedicated data processing system connected to a computer network.

3. The method of claim 1, wherein capturing said deployment information includes refreshing said deployment information.

4. The method of claim 1, wherein capturing said deployment information includes referencing deployment information stored from a previous instance of deployment of one or more data processing systems.

5. The method of claim 1, wherein said deployment information includes information selected from the group of information consisting of: disk drive partitions, disk drive settings, disk array controller settings, PCI device settings, non-PCI device settings, firmware settings, fixed code settings, operating system information, application software package information, user settings, personalization information, or configuration information.

6. The method of claim 1, wherein said deployment information includes a hardware portion of a configuration and a remaining portion of said configuration, and said intelligently deploying can update said hardware portion of said configuration on a data processing system of said one or more data processing systems before software image deployment, without destructively modifying said remaining portion of said configuration of said one or more data processing systems.

7. The method of claim 1, wherein said deployment information includes a hardware portion of a configuration and a remaining portion of said configuration, and said intelligently deploying can update said hardware portion of said configuration on a data processing system of said one or more data processing systems that has already been configured, without destructively modifying said remaining portion of said configuration of said one or more data processing systems.

8. A computer network to facilitate the intelligent deployment of one or more data processing systems, comprising:
one or more data processing systems to be intelligently deployed;
one or more reference data processing systems containing deployment information;
a means for transmission capable of conveying said deployment information to said one or more data processing systems; and
a dedicated data processing system containing deployment information copied from said one or more reference data processing systems, wherein said dedicated data processing system conveys to said one or more data processing systems over said means for transmission a package of deployment information selected from said deployment information, which is based on said deployment information that was captured, upon receiving a command from a user.

9. The computer network of claim 8, further comprising:
a memory in said dedicated data processing system to store said package of said deployment information.

10. The computer network of claim 8, wherein capturing said deployment information includes referencing deployment information stored from a previous instance of intelligent deployment of one or more data processing systems.

11. The computer network of claim 8, wherein said deployment information includes information selected from the group of information consisting of: disk drive partitions, disk drive settings, disk array controller settings, PCI device settings, non-PCI device settings, firmware settings, fixed code settings, operating system information, application software package information, user settings, personalization information, or configuration information.

12. The computer network of claim 8, wherein said deployment information includes a hardware portion of a configuration and a remaining portion of said configuration, and said computer network can update said hardware portion of said configuration on a data processing system of said one or more data processing systems before software image deployment, without destructively modifying said remaining portion of said configuration of said one or more data processing systems.

13. The computer network of claim 8, wherein said deployment information includes a hardware portion of a configuration and a remaining portion of said configuration, and said computer network can update said hardware portion of said configuration on a data processing system of said one or more data processing systems that has already been configured, without destructively modifying said remaining portion of said configuration of said one or more data processing systems.

14. A computer program embodied on electronically-readable media, containing instructions to facilitate the deployment of one or more data processing systems, comprising:
a program code segment to capture deployment information from a reference data processing system to deploy on said one or more data processing systems, wherein said deployment information is stored in a memory;
a program code segment to select said one or more data processing systems;
a program code segment to select a package of said deployment information to be deployed on said one or more data processing systems; and
a program code segment to intelligently deploy said one or more data processing systems upon receiving a command from a user, including program code to reference said package of said deployment information that is stored in said memory.

15. The computer program of claim 14, wherein said memory that stores said package of said deployment information is included in a dedicated data processing system.

16. The computer program of claim 14, wherein said program code segment to capture deployment information from a reference data processing system to deploy on said one or more data processing systems is executed on a data processing system coupled to a network of data processing systems.

17. The computer program of claim 14, wherein said program code segment to select one or more data processing systems to be included in said one or more data processing systems is executed on a data processing system coupled to a network of data processing systems.

18. The computer program of claim 14, wherein said program code segment to select a package of said deployment information to be deployed on said one or more data processing systems is executed on a data processing system coupled to a network of data processing systems.

19. The computer program of claim 14, wherein said program code segment to intelligently deploy said one or more data processing systems upon receiving a command from a user interacts with a network of data processing systems.

20. The computer program of claim 14, wherein said electronically-readable memory is a non-volatile memory selected from the group of non-volatile memories consisting of: a magnetic disk drive, a magneto-optic disk drive, a floppy diskette, a compact disc, and a flash memory.
